(19) United States
(12) Patent Application Publication
(10) Pub. No.: US 2021/0318166 A1
(43) Pub. Date: Oct. 14, 2021

(54) CONTINUOUS AERIAL CABLE MONITORING USING DISTRIBUTED ACOUSTIC SENSING (DAS) AND OPERATIONAL MODAL ANALYSIS (OMA)

(71) Applicant: NEC Laboratories America, Inc., Princeton, NJ (US)

(72) Inventors: Yangmin DING, North Brunswick, NJ (US); Yue TIAN, Princeton, NJ (US); Sarper OZHARAR, Princeton, NJ (US); Ting WANG, West Windsor, NJ (US)

(73) Assignee: NEC Laboratories America, Inc., Princeton, NJ (US)

(21) Appl. No.: 17/227,336

(22) Filed: Apr. 11, 2021

Related U.S. Application Data
(60) Provisional application No. 63/009,639, filed on Apr. 14, 2020.

(51) Int. Cl. G01H 9/00; G01D 5/353

(52) U.S. Cl. CPC G01H 9/004; G01D 5/35361

(57) ABSTRACT

An advance in the art is made according to aspects of the present disclosure directed to distributed fiber optic sensing systems (DFOS), methods, and structures that advantageously provide the continuous monitoring of aerial cables using distributed acoustic sensing (DAS) and operational modal analysis (OMA).

### CROSS REFERENCE

This disclosure claims the benefit of U.S. Provisional Patent Application Ser. No. 63/009,639 filed 14 Apr. 2020 the entire contents of which is incorporated by reference as if set forth at length herein.

### TECHNICAL FIELD

This disclosure relates generally to distributed fiber optic sensing (DFOS) and more particularly to continuous aerial cable monitoring uding distributed acoustic sensing (DAS) and operational modal analysis (OMA).

### BACKGROUND

Aerial fiber optic cables are designed and manufactured for outdoor installation—suspended from utility poles, pylons, or other structures. Oftentimes, such cables are used for secondary trunk-level (and below) communications providing such services as television and telecommunications applications. Unfortunately, aerial cables are susceptible to many environmental conditions and events that may produce a failure and loss of service. Given the contemporary importance of services and applications provided by such aerial fiber optic cables, systems, methods, and structures that provide for their continuous monitoring would represent a welcome addition to the art.

### SUMMARY

An advance in the art is made according to aspects of the present disclosure directed to distributed fiber optic sensing systems (DFOS), methods, and structures that advantageously provide the continuous monitoring of aerial cables using distributed acoustic sensing (DAS) and operational modal analysis (OMA).

In sharp contrast to the prior art, systems, methods and structures according to aspects of the present disclosure determine change(s) in status of an optical fiber sensor as part of DFOS/DAS system by: 1) directly detecting dynamic strain events within the fiber; and 2) detect static changes to the optical fiber—where there is no discernable change in strain—by an operational modal analysis (OMA) technique that determines a natural frequency of the fiber at points along its length and reports alarms when such natural frequency(ies) are not within pre-determined threshold(s).

In further sharp contrast to the prior art, systems, methods, and structures according to aspects of the present disclosure advantageously transform existing aerial optical cable into sensing element(s) using DAS interrogator for data collection and dynamic event detection in addition to advantageously employing the natural frequency to cable status monitoring without requiring artificial excitation for static event detection.

As we shall show and describe, systems, methods, and structures according to the present disclosure utilize DAS and OMA The key principles behind this invention are the utilization of DAS and OMA to determine the natural frequency of the cable, thus providing the continuous monitoring and determination of the “health” of the aerial cable.

### BRIEF DESCRIPTION OF THE DRAWING

A more complete understanding of the present disclosure may be realized by reference to the accompanying drawing in which:

FIG. 1 is a schematic diagram illustrating a prior art DFOS system;

FIG. 2 is a schematic diagram illustrating threats to aerial optical fiber cables according to aspects of the present disclosure;

FIG. 3 is a schematic diagram illustrating aerial optical fiber cable monitoring by DAS and OMA according to aspects of the present disclosure; and

FIG. 4(A) and FIG. 4(B) are: FIG. 4(B) an outline of operation for systems, methods, and structures according to aspects of the present disclosure and FIG. 4(B) shows a schematic diagram illustrating an operational architecture of aerial optical fiber cables health monitoring based on DAS and OMA corresponding to the outline of FIG. 4(A), according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

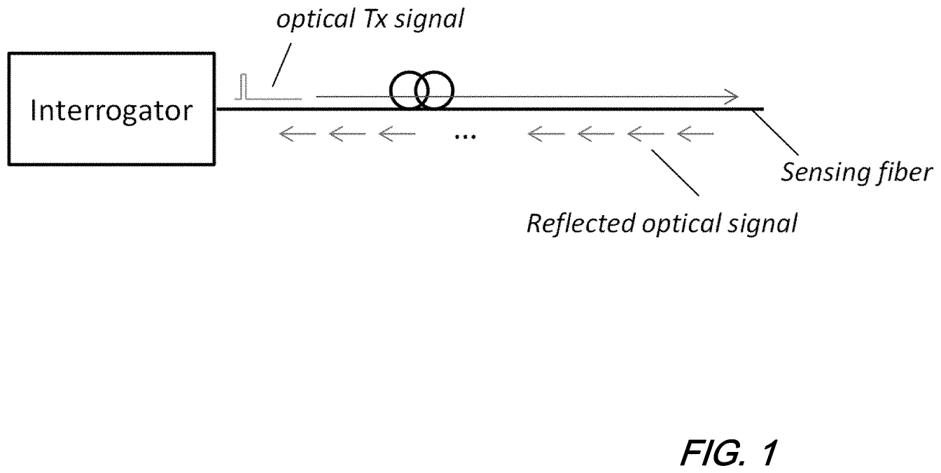

By way of some additional background—and with initial reference to FIG. 1 which shows a schematic diagram illustrating a coded constant-amplitude DFOS system with out-of-band signal generation according to aspects of the present disclosure—we begin by noting that distributed fiber optic sensing (DFOS) is an important and widely used technology to detect environmental conditions (such as temperature, vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Those skilled in the art will understand and appreciate that by implementing a signal coding on the interrogation signal enables the sending of more optical power into the fiber which can advantageously improve signal-to-noise ration (SNR) of Rayleigh-scattering based system (e.g. distributed acoustic sensing or DAS) and Brillouin-scattering based system (e.g. Brillouin optical time domain reflectometry or BOTDR).

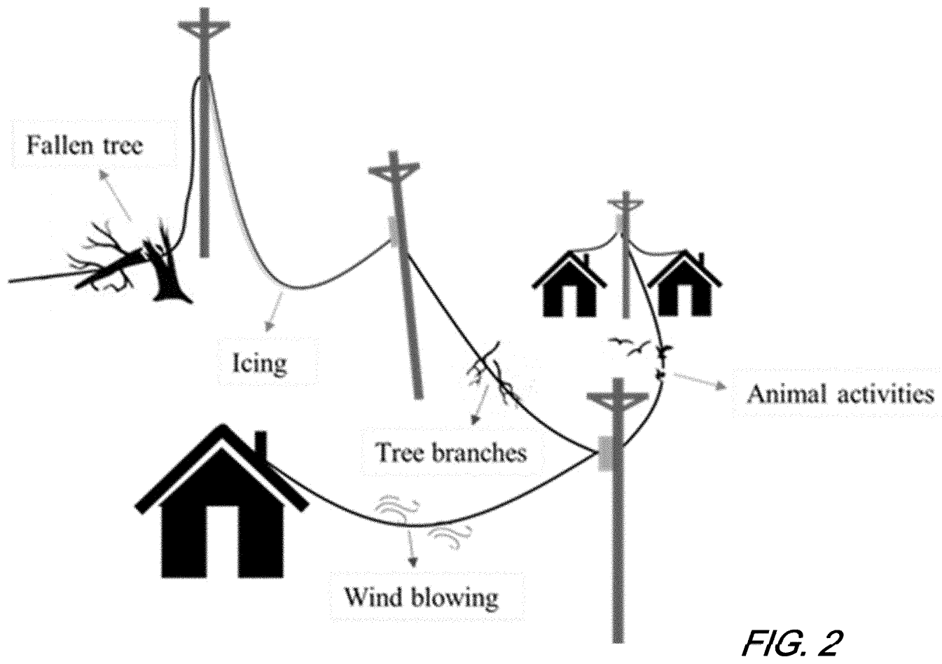

FIG. 2 is a schematic diagram illustrating numerous environmental threats to aerial optical fiber cables according to aspects of the present disclosure. As noted previously, aerial fiber optic cables are designed and manufactured for outdoor installation—suspended from utility poles or pylons—and find widespread applicability for cable television and telecommunications application. Unfortunately, however, aerial cables are easily affected by environmental conditions and events as illustratively depicted in FIG. 2. Those skilled in the art will appreciate that threats posed by such environmental conditions and events may include—but are not limited to—fallen tree/tree branches, ice, automobile or other impact, weather, wind, rain, sleet, snow, leaning/failing pole structures along with any degradation in the mechanical characteristics of a pole itself. Those skilled in the art will appreciate further that—if not handled properly and timely—those environmental conditions/events acting upon aerial fiber optic cables will eventually result in their failure and disruption of service(s) provided thereby.

Note that for dynamic events affecting an aerial fiber/cable such as weather, animals, accidents, a distributed acoustic sensor (DAS) according to aspects of the present disclosure can advantageously and directly detect any change of status of the fiber by detecting/identifying strain events occurring within the fiber itself.

For static events that affect the fiber/cable such as a hanging tree branch or a fallen tree impacting the aerial cable—since there is no change in strain to be detected—our inventive systems, methods, and structures according to the present disclosure can advantageously employ our operational modal analysis (OMA) to raw strain data received by DAS operation to obtain natural frequencies of the aerial cable. Then, the natural frequencies of the cable at different time intervals are compared with those of the baseline cable model (initial state). The difference between each natural frequency component at a given time interval can be compared with that of the initial state. A change in natural frequency indicates a change of the cable status.

As previously noted, our systems, methods, and structures according to aspects of the present disclosure advantageously provide continuous optical cable monitoring by transforming existing aerial cable into a sensing element through the effect of the DOFS/DAS operation and interrogator for interrogation, detection, collection, and identification of specific dynamic events or conditions that affect the fiber optic cable. Of further advantage, our systems, methods, and structures according to aspects of the present disclosure provide static event detection through the application of natural frequency measurements to cable status monitoring under normal, ambient conditions without external excitation.

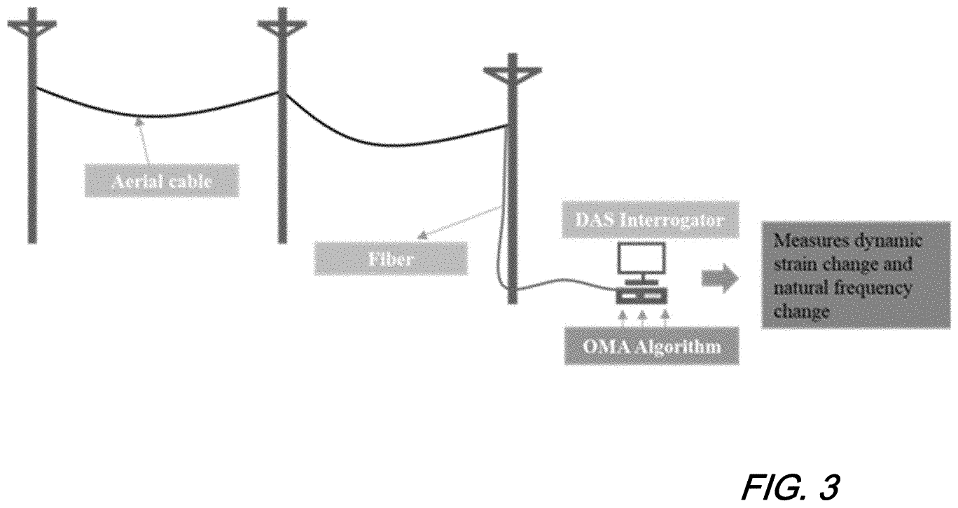

FIG. 3 is a schematic diagram illustrating aerial optical fiber cable monitoring by DAS and OMA according to aspects of the present disclosure. As noted, systems, methods, and structures according to aspects of the present disclosure advantageously employ DAS and OMA to determine the natural frequency of the fiber optic cable, thus providing continuous monitoring of the aerial cable health status.

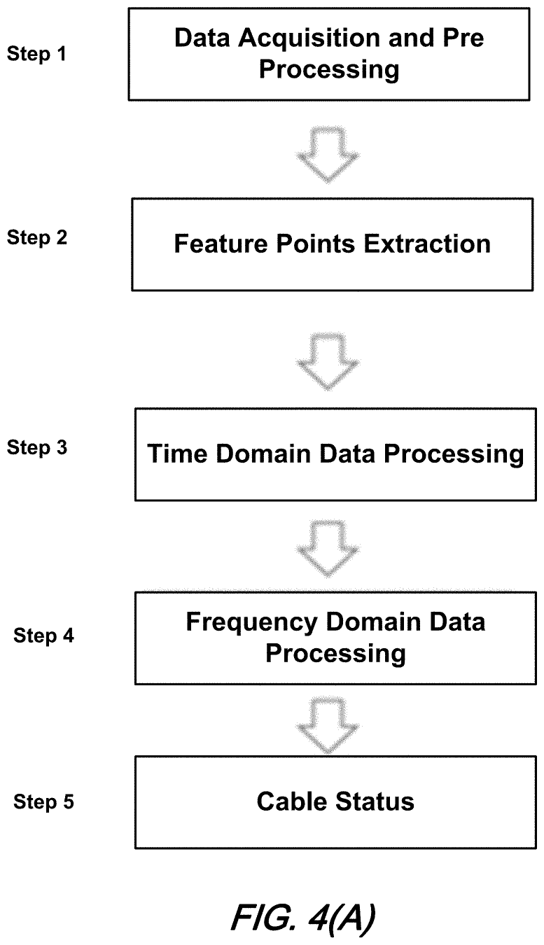

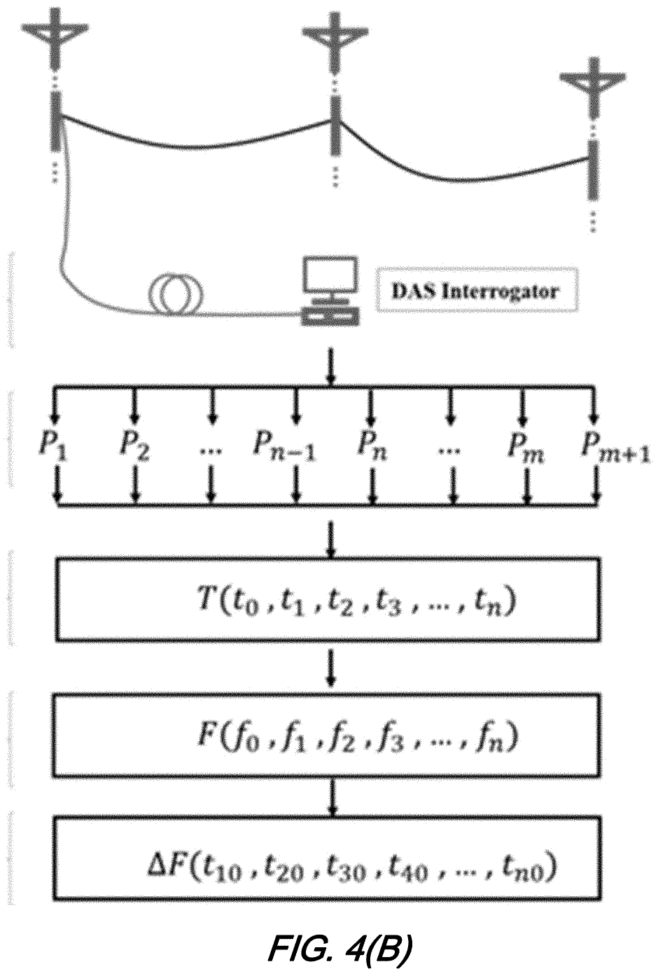

FIG. 4(A) and FIG. 4(B) are: FIG. 4(B) an outline of operation for systems, methods, and structures according to aspects of the present disclosure and FIG. 4(B) shows a schematic diagram illustrating an operational architecture of aerial optical fiber cables health monitoring based on DAS and OMA corresponding to the outline of FIG. 4(A), according to aspects of the present disclosure.

FIG. 4(B) is a schematic diagram illustrating an operational architecture of aerial optical fiber cables health monitoring based on DAS and OMA according to aspects of the present disclosure. As shown in FIG. 4(B), the system utilizes an existing aerial cable as distributed sensor(s) to capture the dynamic response of the cable under ambient excitation. Importantly, the optical fiber cable employed may be actively carrying telecommunications or other traffic in the form of optical signals simultaneously with the continuous monitoring via DOFS/DAS that is the subject of the present disclosure.

As illustratively shown in the FIG. 4(A), operational steps according to aspects of the present disclosure include: 1) Data Acquisition and PreProcessing; 2) Feature Point Extraction; 3) Time Domain Data Processing; 4) Frequency Domain Data Processing; and 5) Cable Status Determination.

These steps may be further understood as follows.

Step 1: Connect DAS interrogator to the aerial optical cable and collect strain signal along the length of the entire optical cable. Data quality check-up, filtering, and windowing may also be applied in this step to confirm the validity of any raw data.

Step 2: Based on the sampling rate of DAS interrogator and cable length, extract feature points along the cable (P₀, P₁, P₂, Pₘ₊₁) for OMA. For example, with a spatial resolution of 1 m, for a cable length of 30 m, there are 30 data points can be extracted.

Step 3: Determine the time interval for OMA. The OMA results from the first time interval treated as an initial status of the cable. For example, given the time interval Δt=20 minutes, set t₀=20 as the initial status, t₁=40 as the second status, then the status at n^{th} time interval would be tₙ=n*20.

Step 4: Perform OMA for the time series data from Step 3. In this step, the frequency domain decomposition (FDD) technique will be applied.
a) Estimate the power spectral density matrix Ĝ_{yy} (jω) at discrete frequencies ω=ωᵢ;
b) Perform a singular value decomposition of the power spectral density, i.e. Ĝ_{yy}(jωᵢ)=UᵢSᵢUᵢ^{H}
   where Uᵢ=[uᵢ₁, uᵢ₂, . . . , uᵢₘ] is a unitary matrix holding the singular values uᵤ, Sᵢ is the diagonal matrix holding the singular values sᵢⱼ;
c) For a n degree of freedom cable, pick the n dominating peaks in the power spectral density. These peaks correspond to the natural frequencies of the pole-cable system.
d) Applying finite element analysis or using the analytical model (such as Lumped-Segmentation model) to calculate the cable's natural frequencies. Therefore, the cable's natural frequencies can be uniquely separate from the pole's natural frequency.

Step 5: Repeat the sub-steps a) to c) in Step 4 to obtain the natural frequencies at each time interval and compare the natural frequencies with those from the initial state. If OF meets the threshold the user set, an alarm will be triggered.

At this point, while we have presented this disclosure using some specific examples, those skilled in the art will recognize that our teachings are not so limited. Accordingly, this disclosure should only be limited by the scope of the claims attached hereto.

1. A method for continuous aerial cable monitoring using distributed acoustic sensing (DAS) and operational modal analysis (OMA) coded distributed fiber optic sensing with a distributed fiber optic sensing/distributed acoustic sensing system (DFOS/DAS) system, said system comprising:
a length of optical fiber cable;
a DFOS/DAS interrogator system in optical communication with the length of optical fiber cable; and
an intelligent analyzer configured to analyze DFOS/DAS sensing data received by the DFOS/DAS interrogator system;
the method comprising:
a) operating the DFOS/DAS system and acquiring strain signal data along a length of the optical fiber cable;
b) extracting, from the strain signal data, a set of the data corresponding to feature points along the cable for subsequent OMA;
c) determining a time interval for the OMA and generating a time series of strain signal data at respective feature points;
d) perform OMA for the time series generated in step c, above, using a frequency domain decomposition (FDD) technique;
e) determine the cable's natural frequency from the result of step d; and
f) repeat steps a) to c) above to determine the natural frequency of the cable at each time interval;
g) comparing the natural frequencies determined in step f) to those at an initial state; and
h) generating an alarm if the comparison of step g) exceeds a pre-determined threshold.

2. The method of claim 1 wherein a first time series determined at step c) is the initial state natural frequencies.

3. The method of claim 2 wherein the FDD technique includes estimating a power spectral density matrix Ĝ_{yy}(jω) at discrete frequencies ω=ωᵢ.

4. The method of claim 3 wherein the FDD technique includes a singular value decomposition of the power spectral density
Ĝ_{yy}(jωᵢ)=UᵢSᵢUᵢ^{H}
where Uᵢ=[uᵢ₁, uᵢ₂, . . . , uᵢₘ] is a unitary matrix holding the singular values uᵢⱼ, Sᵢ is the diagonal matrix holding the singular values sᵢⱼ.

5. The method of claim 4 wherein the FDD technique includes n dominating peaks in the power spectral density which correspond to natural frequencies of a pole-cable system.
